(19) United States
(12) Patent Application Publication
(10) Pub. No.: US 2026/0167511 A1
(43) Pub. Date: Jun. 18, 2026

(54) PROCESS

(71) Applicant: Mexichem UK Limited, Runcorn, Cheshire (GB)

(72) Inventor: James WILCOCK, Runcorn, Cheshire (GB)

(21) Appl. No.: 19/125,084

(22) PCT Filed: Oct. 20, 2023
(86) PCT No.: PCT/GB2023/052749

§ 371 Date: Apr. 28, 2025

(30) Foreign Application Priority Data
Oct. 31, 2022 (GB) 2216132.7

(51) Int. Cl. C01D 15/08

(52) U.S. Cl. CPC C01D 15/08

(57) ABSTRACT

A continuous process for the at least partial conversion of a metal carbonate (M(CO₃)ₓ) to a metal bicarbonate (M(HCO₃)_{y}), comprising:
feeding a composition comprising a metal carbonate and a composition comprising water into a reactor to form an admixture of water and metal carbonate;
optionally adding water/a solution of a metal salt;
wherein the reactor is fed with a gas comprising carbon dioxide (CO₂) under elevated pressure.

### FIELD OF THE INVENTION

The present invention relates to a process for the continuous bicarbonation of a metal salt. This process is particularly useful in the production of lithium bicarbonate.

### BACKGROUND OF THE INVENTION

Lithium salts (such as LiPF₆) are used in batteries, such as commercial secondary batteries, an application that exploits its high solubility in non-aqueous, polar solvents.

Lithium salts have a usage as a precursor to the lithium compounds (such as LiPF₆) that are utilized in the Li-ion batteries. Lithium bicarbonate (LiHCO₃) is typically used a precursor compound as it has a high solubility in water (compared to other salts, such as lithium carbonate (Li₂CO₃) and may be transported safely in aqueous solution. Other salts having poorer solubility require larger transportation vessels and thus are less economical to transport.

Currently lithium bicarbonate production occurs by carbonation with CO₂ generally in an aqueous environment in a reactor.

The reaction below

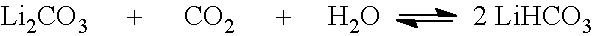

generates a solution of lithium bicarbonate.

The bicarbonation reaction is slightly exothermic.

The process can be batch. These batch processes are often operated at low CO₂ pressure, which is inefficient.

There are also continuous production processes. In the currently used continuous production processes typically an admixture of water and lithium carbonate is charged into a reactor with a source of carbon dioxide (often bubbled through the lithium carbonate solution).

This can be challenging as the initial solubility of lithium carbonate in water is low relative to other lithium salts. Lithium carbonate has a higher solubility in water at lower temperatures.

As the solubility of lithium carbonate is higher at lower temperatures the reactors are generally cooled. The carbon dioxide may be recycled.

In the currently used continuous production processes rapid CO₂ dissolution is not attained. This has a negative impact in that the slow dissolution of CO₂ limits the conversion of lithium carbonate to lithium bicarbonate. The carbon dioxide utilization efficiency can be low at about 30-40%. To address the poor conversion rate large batch reactors are required for industrial scale production. However, even so these large reactors (and the associated equipment) are typically complex, expensive to operate systems.

Thus there is a need for an improved method of producing lithium bicarbonate.

### SUMMARY OF THE INVENTION

According to the present invention there is provided a continuous process for the at least partial conversion of a metal carbonate (M(CO₃)ₓ) to a metal bicarbonate (M(HCO₃)_{y}), comprising:
feeding a composition comprising a metal carbonate and a composition comprising water into a reactor to form an admixture of water and metal carbonate;
optionally adding water/a solution of a metal salt;
wherein the reactor is fed with a gas comprising carbon dioxide (CO₂) under elevated pressure.

The process of the invention has been found to achieve a high conversion of the metal carbonate. The conversion has also been found to occur quickly. It is postulated that this is due (at least in part) to enhanced CO₂ dissolution in the process of the invention. These factors contribute to a benefit in that a smaller reactor (than for the prior art) is needed to operate the process of the invention.

Generally the metal carbonate is or comprises lithium carbonate.

Preferably the reactor comprises a plug flow reactor (PFR) reactor.

Preferably the process of the invention uses co-current flow through the reactor. As the reaction in the process of the present invention has been found to operate quickly and with a high conversion rate it has been found that the bicarbonation reaction can take place in pipework. This eliminates the need to for pressure rated reaction vessels which existing processes batch/continuous require.

The reactor is preferably lined with a resilient material (such as PTFE). The lining is used to avoid (or at least reduce) any metal contamination (e.g. arising from the reactor) of the metal (lithium) bicarbonate and downstream products. In this regard avoiding contamination is not only important for product purity but also to ensure any downstream steps (such as further processing, e.g. fluorination of the metal bicarbonate) operate as intended. Further processing, such as fluorination of the metal bicarbonate has been found to be adversely affected by metal contamination.

A single reactor may be used, or multiple reactors may be used. Where multiple reactors are used these may be series, wherein the output from a reactor is fed to a reactor subsequent in the series. Where multiple reactors are used there may be the possibility of introducing a process step between two (or more) reactors. As an example, there may be a heating/cooling mechanism, such as a heat exchanger (to provide cooling—see below) between reactors. (Alternatively and/or additionally the one or more of the plurality of reactors may have its own cooling mechanism).

The total residence time through the reactor/series of reactors is from about 5 seconds to about 5 minutes, such as about 1 minute to about 4 minutes, e.g. about 3 minutes. Here, it will be appreciated that residence time will depend on a number of factors, including; the concentration of the reactants, sparging, the scale of the reaction and shear velocities. For example, the formation of large gas bubbles may require a longer residence time.

Generally the product metal bicarbonate is in the form of a salt solution.

The metal bicarbonate salt solution is preferably extracted from the final reactor and transferred to a storage tank.

Optionally there may be a purifying step. As an example, non-desired metals ions (such as Mg²⁺ and/or Ca²⁺ when the desired metal is lithium) and their salts, may be removed. Preferred forms of ion removal include ion-exchange. It has been found the bicarbonate solution remains stable: any unreacted metal carbonate (M(CO₃)ₓ/Li₂CO₃) has been found to remain in solution and not precipitate for several days (despite the typical reduction in pressure, when compared to the bicarbonation step). Additionally it has been found that there is little or no decarbonation/reverse reaction to the metal carbonate.

The optional addition of the solution of metal salt acts as a dilution step to dilute the admixture of water and metal carbonate. The dilution salt is preferably not involved in the metal bicarbonate forming reaction; in other words the dilution salt is preferably inert as far as the metal bicarbonate forming reaction is concerned. The dilution salt is preferably used as a high initial metal carbonate (M(CO₃)ₓ) concentration is employed to minimise the size of slurring tanks/continuous slurry mixer. This high initial metal carbonate (M(CO₃)ₓ) concentration is likely to yield a product metal bicarbonate (M(HCO₃)_{y}), which is above the solubility limit of metal (lithium) bicarbonate (M(HCO₃)_{y}). The dilution salt is used to dilute the slurry to the desired (maximum) bicarbonate concentration.

As an alternative pure water could be used to achieve the required concentration of metal (lithium) bicarbonate. Thus in an alternative instead of optionally adding a solution of a metal salt; the optional addition of water may be used.

The dilution salt preferably comprises a similar/identical metal salt to the metal carbonate; e.g. where the metal carbonate comprises lithium carbonate the dilution salt comprises a lithium salt. Preferably the metal dilution salt comprises a metal halide, such as a metal fluoride salt. Indeed the dilution salt solution is preferably obtained from a downstream step (such as further processing, e.g. fluorination of the metal bicarbonate). Hence, the dilution salt preferably comprises lithium fluoride (LiF). The dilution salt solution can also have the benefit of precipitating unwanted ions such as those of Ca²⁺ and/or Mg²⁺. These can then be removed by filtration prior to ion exchange. In this regard in a preferred embodiment where the dilution salt comprises lithium fluoride unwanted ions such as those of Ca²⁺ and/or Mg²⁺ have been found to be precipitated as the respective fluoride.

The initial concentration of metal carbonate (pre-dilution) is preferably in the range of 0.1-500 g/L, more preferably 120-240 g/L (1.6 to 3.3 molar). The concentration of metal bicarbonate (post-dilution) is up to 75 g/L (up to 1.2 molar). The metal dilution salt concentration is preferably about 0.1 to 2 g/L, more preferably about 1.5 g/L (about 0.06 molar).

Preferably the gas comprising carbon dioxide (CO₂) (preferably consisting (substantially) of CO₂) is applied at a pressure of from 0.1 to 100 barg, more preferably from 5 to 10 barg.

The amount of the gas comprising carbon dioxide (CO₂) fed into the reactor is preferably such that there is at least a stoichiometric/equimolar amount and more preferably an excess of carbon dioxide (CO₂) to achieve carbonation of the metal carbonate (M(CO₃)ₓ). At least a portion of gas comprising carbon dioxide (CO₂) is preferably recovered from and/or recycled to the reactor.

Generally the gas comprising carbon dioxide is applied to the reactor by injection through a gas injector. The gas injector is preferably disposed beneath the expected level of liquid in the reactor such that the gas comprising carbon dioxide is introduced into the reaction liquor in the form of bubbles/micro-bubbles. There may be a single gas injector or a plurality of gas injectors per reactor. Where there are multiple reactors there may be a differing number of injector(s) and/or a differing nature of injector(s) per reactor. Excessive gas dispersion may be reduced/precluded by the use of a suitable mixer, such as an in-line mixer.

Where there is a plurality of gas injectors, the injectors/each injector may differ from one another. As an example, each injector may have its own mass flow control for optimisation of gas/liquid ratios.

The gas injector is preferably in the form of a gas sparger. Examples of preferred gas spargers include sintered metal gas spargers. These may be optimised to produce a required exit velocity of fine gas bubbles.

As the bicarbonation reaction is slightly exothermic the reactor is preferably cooled. Preferably the reactor is cooled to less than 30° C. and more preferably to less than 20° C. Higher temperatures can lead to problems with precipitation of metal carbonate (M(CO₃)ₓ). Cooling is preferably performed by standard cooling methods such as the use of heat exchangers. Also by employing pressurised CO₂ injection, the process benefits from the Joule-Thompson effect of cooling.

Generally the conversion of the metal carbonate is at least partial. Preferably the conversion of the metal carbonate is such that all of the metal carbonate fed to the reactor is at least converted into a soluble form (i.e. not in the form of a suspension/slurry). In the event that full dissolution is not achieved (identified by means such as turbidity analysis) the product solution can be redirected back to the reactor for a further carbonation step.

### EXAMPLE 1—PREPARATION OF LITHIUM BICARBONATE (LIHCO₃)—LABORATORY SCALE EXAMPLE

Lithium carbonate powder was added to 25 L of demineralised water (or mother liquor from LiF process, saturated in LiF at a concentration of approx. 1.3 g/L) in a plastic vessel to make a slurry containing 40-60 g/L Li₂CO₃.

The slurry was mixed using a standard overhead stirrer with coated impeller to dissolve Li₂CO₃ up to its solubility limit (˜13 g/L).

The Li₂CO₃slurry was then pumped by a diaphragm pump at a discharge pressure of 8 barg, and forward flowrate to the plug flow reactors (PFRs) of 1 L/min, measured by an inline rotameter.

There were 3 PFRs in series. Each PFR comprised a 30 m length of ¼″ ID PFA tube.

At the start of each PFR is a CO₂ injection point, comprising a T-piece and sintered nozzle with 2-micron pore size.

CO₂ was supplied from a compressed gas cylinder regulated to 8.5-9 barg. Minimum total CO₂ addition was 16 g/min at 40 g/L or 28 g/min at 60 g/L controlled by in-line mass flow control. The rate of CO₂ addition at each injection point could be controlled independently.

Total residence time was approximately 3 minutes, after which all Li₂CO₃ was observed to be dissolved. This was apparent visually. The concentration was measured by conductivity and IC.

After passing through the PFRs the solution was passed through a back pressure controller which maintained a system back pressure of 6 barg. Across the process the pressure drop was approx. 2 bar.

Bicarbonate solution was then collected in 25 L bottles for storage.

No precipitated impurities were observed as the Li₂CO₃powder contained very low levels of impurities. Separate experiments were carried out using dosed impurities to evaluate IX performance.

The bicarbonate solution (up to 60 g/L) has been found to remain stable. Any residual Li₂CO₃ has been found to remain in solution and does not precipitate for several days despite the reduction in pressure. This allows the bicarbonate solution to be stored in atmospheric storage tanks ready for downstream processing steps, eliminating the need for higher cost pressure vessels.

1. A continuous process for the at least partial conversion of a metal carbonate (M(CO₃)ₓ) to a metal bicarbonate (M(HCO₃)_{y}), comprising:
feeding a composition comprising a metal carbonate and a composition comprising water into a reactor to form an admixture of water and metal carbonate;
optionally adding water/a solution of a metal salt;
wherein the reactor is fed with a gas comprising carbon dioxide (CO₂) under elevated pressure.

2. The process according to claim 1, wherein the metal carbonate is or comprises lithium carbonate.

3. The process according to claim 1, wherein the reactor comprises a plug flow reactor (PFR) reactor.

4. The process according to claim 1, wherein the reactor comprises a single reactor or multiple reactors.

5. The process according to claim 4, wherein the reactor comprises multiple reactors configured in series.

6. The process according to claim 4, wherein the total residence time through the single reactor or multiple reactors is about 3 minutes.

7. The process according to claim 1, wherein the metal bicarbonate salt solution is extracted from the reactor and transferred to a storage tank.

8. The process according to claim 1, wherein an initial concentration of the metal carbonate (pre-dilution) is in the range of 120-240 g/L (1.6 to 3.3 molar).

9. The process according to claim 1, wherein the gas comprising carbon dioxide (CO₂) is applied at a pressure of 5 to 10 barg.

10. The process according to claim 1, wherein the gas comprising carbon dioxide is applied to the reactor by injection through a gas injector.

11. The process according to claim 1, wherein the reactor is cooled to less than 20° C.

12. The metal bicarbonate produced by a process according to claim 1.
